(19) United States
(12) Patent Application Publication
(10) Pub. No.: US 2002/0002744 A1
(43) Pub. Date: Jan. 10, 2002

(54) Quick-connect hand tool

(76) Inventor: Kimothy C. Levia, Quebec (CA)

Correspondence Address: WEISS & MOY PC, 4204 NORTH BROWN AVENUE, SCOTTSDALE, AZ, 85251, US

(21) Appl. No.: 09/865,034

(22) Filed: May 23, 2001

Related U.S. Application Data
(60) Provisional application No. 60/206,284, filed on May 23, 2000.

(51) Int. Cl. B25F 1/00

(52) U.S. Cl. 7/100

(57) ABSTRACT

A quick-connect hand tool for use in automotive repair and other repair/manufacture needs comprising a handle, a quick-connect attachment device coupled to the handle and at least one tool accessory dimensioned to releasably couple to the quick-connect attachment device. Preferably, the handle portion is hollow, and permits the storage therein of a plurality of tool attachments.

### RELATED APPLICATION

This application claims priority to a corresponding provisional application U.S. Ser. No. 60/206,284, filed May 23, 2000 in the name of the applicant of this application.

### FIELD OF THE INVENTION

This invention relates generally to hand tools for use in repair work and, more specifically, to a quick-connect hand tool for automotive repair or other repair/manufacture needs having at least one accessory dimensioned to be coupled to the hand tool through a quick-connect attachment device.

### BACKGROUND OF THE INVENTION

Automotive repair, as well as other forms of manufacture and repair work, requires the use of different hand tools to perform different tasks. For example, picks, hooks, and magnets are often needed to pry, probe, or poke, or to retrieve small objects in a work area. One who is involved in repair work generally needs, therefore, to purchase, store and maintain the different tools to which resort may be needed. However, it is both costly and inconvenient to acquire and store multiple tools. A need therefore existed for a quick-connect hand tool capable of releasably locking into place various tool attachments while maintaining a single handle for use. Further, a need existed for a hand tool capable of mating a single handle to a plurality of tool attachments that further permits the storage of the attachment within the tool handle itself, both for purposes of saving storage space and for providing ready access to a needed tool during a work situation. The present invention satisfies these needs and provides other, related, advantages.

### SUMMARY OF THE INVENTION

An object of the present invention is to provide a quick-connect hand tool capable of releasably locking a plurality of tool attachments to a single handle.

It is a further object of the present invention to provide a quick-connect hand tool capable of storing a plurality of tool attachments in a handle portion thereof.

### BRIEF DESCRIPTION OF THE PREFERRED EMBODIMENTS

In accordance with one embodiment of the present invention, a quick-connect hand tool is disclosed, comprising, in combination, a handle having a first end and a second end, a quick-connect attachment device fixedly coupled to the second end of the handle; and at least one tool accessory having a first end and a second end, the first end is dimensioned to releasably couple to the quick-connect attachment device and the second end of the tool accessory comprises a tool tip.

In accordance with still another embodiment of the present invention, a method for using multiple tool accessories to effect repair is disclosed, comprising, in combination the steps of providing a handle having a first end and a second end, providing a quick-connect attachment device fixedly coupled to the second end of the handle; providing at least one tool accessory having a first end and a second end, the first end is dimensioned to releasably couple to the quick-connect attachment device and the second end of the tool accessory comprises a tool tip, and releasably coupling the second end of the tool accessory to the quick-connect attachment device.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of the preferred embodiment of the quick-connect hand tool of the present invention.

FIG. 2 is a side, cross-sectional view of the quick-connect hand tool of FIG. 1, showing an accessory housed in the interior of the quick-connect tool handle.

FIG. 3 is a perspective view of exemplary accessories.

### DETAILED DESCRIPTION OF THE PREFERRED EMBODIMENTS

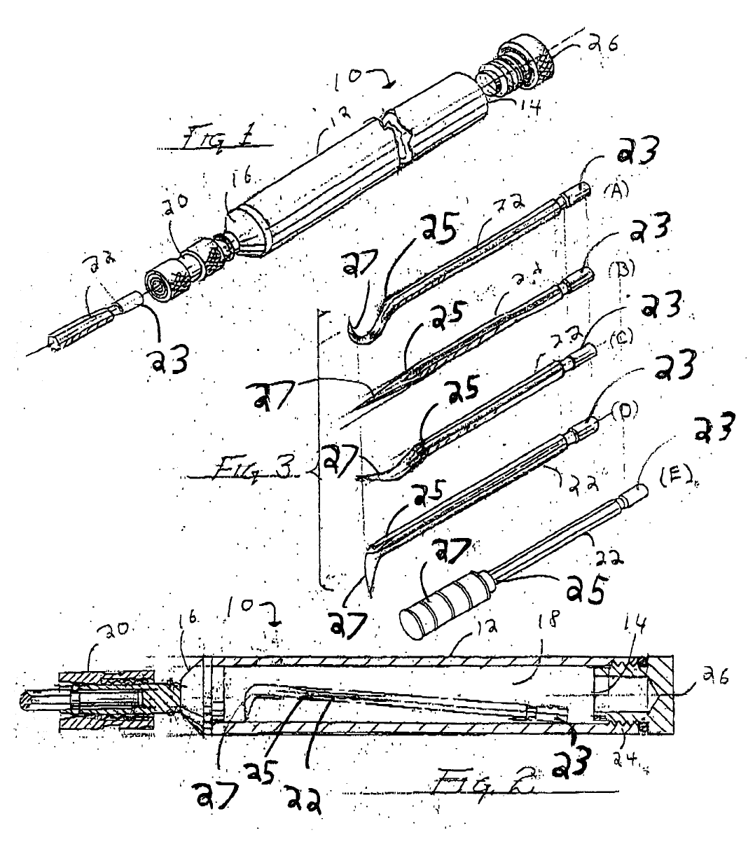

Referring to FIGS. 1 and 2, the quick-connect hand tool, hereinafter quick-connect hand tool 10, of the present invention is shown. The quick-connect hand tool 10 comprises a handle 12 having a first end 14 and a second end 16, a quick-connect attachment device 20 fixedly coupled to the second end 16 of the handle 12 and at least one tool accessory 22 having a first end 23 and a second end 25, the first end 23 is dimensioned to releasably couple to the quick-connect attachment device 20 and the second end 25 comprises a tool tip 27. The quick-connect attachment device 20 is of the type known in the art.

Referring now to FIGS. 1-3, the quick-connect hand tool 10 further comprises at least one tool accessory 22 of the type used in automotive repair or other repair/manufacture needs, releasably coupled to the quick-connect attachment device 20. Illustrated herein, by way of example of the types of tool accessories 22 useable with the quick-connect hand tool 10 are picks, magnets and hooks. Other tool accessories (not shown) could, of course, also be used, including for example cutting blades, deburring tools, and files.

In order to permit attachment of the tool accessories 22 to the quick-connect attachment device 20, the tool accessories 22 preferably have an area of reduced diameter proximate the first end 23, as shown in FIGS. 1-3. In the preferred embodiment, the quick-connect hand tool 10 comprises four hook and pick tool accessories 22 of various configurations (shown in FIG. 3), although it should be understood that substantial benefit could be derived from a configuration of the quick-connect hand tool 10 comprising as few as one tool accessory 22, two to three tool accessories 22, or more than four tool accessories 22.

In the preferred embodiment, the handle 12 defines a hollow, preferably cylindrical, chamber 18 between the first end 14 and the second end 16. Referring now to FIG. 2, the chamber 18 is preferably dimensioned to store the tool accessories 22 when they are not needed. The chamber 18 is preferably large enough to hold a full set of tool accessories 22, so that the entire set of tool accessories 22 can be held therein when the quick-connect hand tool 10 is not in use. While, in the preferred embodiment, the handle 12 defines a chamber 18 dimensioned to house the tool accessories 22, it should be clearly understood that substantial benefit could be derived from an alternative configuration of the handle 12 which defines a chamber 18 dimensioned to hold fewer than the entire set of tool accessories 22 or a handle 12 which lacks a chamber 18 altogether. Preferably, the first end 14 of the handle 12 defines a threaded aperture 24 (shown in FIG. 2) dimensioned to mate with a corresponding threaded screw cap 26, although it should be clearly understood that substantial benefit could be derived from an alternative configuration of the handle 12 of the quick-connect hand tool 10 which does not define a threaded aperture 24, or in which the first end 14 of the handle 12 is dimensioned to mate with a cap 26 in a different manner.

While the invention has been particularly shown and described with reference to preferred embodiments thereof, it will be understood by those skilled in the art that the foregoing and other changes in form and details may be made therein without departing from the spirit and scope of the invention.

I claim:

1. A quick-connect hand tool comprising, in combination:
a handle having a first end and a second end;
a quick-connect attachment device fixedly coupled to said second end of said handle; and
at least one tool accessory having a first end and a second end, said first end of said tool accessory is dimensioned to releasably couple to said quick-connect attachment device and said second end of said tool accessory comprises a tool tip.

2. The quick-connect hand tool of claim 1 wherein said handle defines a hollow chamber between said first end and said second end.

3. The quick-connect hand tool of claim 2 wherein said first end of said handle defines a threaded aperture dimensioned to mate with a corresponding threaded screw cap.

4. The quick-connect hand tool of claim 1 wherein said at least one tool accessory is a pick.

5. The quick-connect hand tool of claim 1 wherein said at least one tool accessory is a hook.

6. The quick-connect hand tool of claim 1 wherein said at least one tool accessory is a magnet.

7. The quick-connect hand tool of claim 2 wherein said at least one tool accessory is dimensioned to be housed in said chamber of said handle.

8. The quick-connect hand tool of claim 2 wherein said chamber is dimensioned to house at least two tool accessories.

9. The quick-connect hand tool of claim 2 wherein said chamber is substantially cylindrical-shaped.

10. A method for using multiple tool accessories to effect repair comprising, in combination, the steps of:
providing a handle having a first end and a second end;
providing a quick-connect attachment device fixedly coupled to said second end of said handle;
providing at least one tool accessory having a first end and a second end, said first end is dimensioned to releasably couple to said quick-connect attachment device and said second end of said tool accessory comprises a tool tip; and
releasably coupling said second end of said tool accessory to said quick-connect attachment device.

11. The method of claim 10 wherein said handle defines a hollow chamber between said first end and said second end.

12. The method of claim 10 wherein said first end of said handle defines a threaded aperture dimensioned to mate with a corresponding threaded screw cap.

13. The method of claim 10 wherein said at least one tool accessory is a pick.

14. The method of claim 10 wherein said at least one tool accessory is a hook.

15. The method of claim 10 wherein said at least one tool accessory is a magnet.

16. The method of claim 11 wherein said at least one tool accessory is dimensioned to be housed in said chamber of said handle.

17. The method of claim 11 wherein said chamber is dimensioned to house at least two tool accessories.

18. The method of claim 11 wherein said chamber is substantially cylindrical-shaped.

19. The method of claim 12 further comprising the steps of:
removing said screw cap;
removing said at least one tool accessory;
releasably coupling said second end of said tool accessory to said quick-connect attachment device; and
securing said screw cap.
